(19) United States
(12) Patent Application Publication
(10) Pub. No.: US 2016/0186789 A1
(43) Pub. Date: Jun. 30, 2016

(54) Magnetic Closure System

(71) Applicant: Revolutionary Design, Inc., San Clemente, CA (US)

(72) Inventors: Linda Nelson, Huntington Beach, CA (US); Luke Bilisoly, Anaheim, CA (US); Tim Boettcher, Anaheim, CA (US); Arthur J. Coury, Boston, MA (US)

(73) Assignee: Revolutionary Design, Inc., San Clemente, CA (US)

(21) Appl. No.: 14/968,059

(22) Filed: Dec. 14, 2015

Related U.S. Application Data
(63) Continuation-in-part of application No. 14/600,990, filed on Jan. 20, 2015.
(60) Provisional application No. 61/929,261, filed on Jan. 20, 2014.

(51) Int. Cl. F16B 1/00

(52) U.S. Cl. CPC F16B 1/00; F16B 2001/0035

(57) ABSTRACT

A magnetic closure system is provided that includes closure members that mate which each other along an elongated seam. The closure members comprise a plurality of magnetic pairs spaced along the elongated seam. The magnetic components are aligned with corresponding pairs, such that an upper contact surface of a first component is attracted to the upper contact surface of a second component via magnetic attraction, e.g., the first component and the second component configured with opposing polarity to provide magnetic attraction therebetween. In this manner, the closure system resists unintended separation.

### CROSS REFERENCE TO RELATED APPLICATION

This application is a continuation-in-part of application Ser. No. 14/600,990, filed Jan. 20, 2015, which claims the benefit of application Ser. No. 61/929,261, filed Jan. 20, 2014, both of which are herein incorporated by reference.

### FIELD OF THE INVENTION

The present invention relates generally to closure systems and, more particularly, to magnetic closure system.

### BACKGROUND OF THE INVENTION

Magnetic closure systems have been utilized in various applications, to provide a closure that secures quickly while requiring minimal interaction from the user. Typically, such closures rely chiefly or exclusively upon the magnetic attraction between opposing components to maintain the closure.

Although current approaches are generally effective, shortfalls exist. For example, current magnetic closures can inadvertently open. Moreover, current magnetic closures can be expensive to manufacture.

It should be appreciated that there remains a need for closure system that addresses these concerns. The present invention fulfills this need and others.

### SUMMARY OF THE INVENTION

Briefly, and in general terms, a magnetic closure system is provided that include a plurality of The closure system includes that mate which each other to secure the panels to each other along an elongated seam. The closure members comprise a plurality of magnetic pairs spaced along the elongated seam. The magnetic components are aligned with corresponding pairs, such that an upper contact surface of a female component is attracted to the upper contact surface of the male component via magnetic attraction, e.g., the male component and the female component configured with opposing polarity to provide magnetic attraction therebetween. In this manner, the closure system resists unintended separation.

More specifically, in an exemplary embodiment, the closure members include a generally planar, elongated support member having an upper surface and a lower surface and a plurality of magnetic components disposed on and attached to the upper surface of the support member in a linear manner. Each of the magnetic components has a lower side facing the upper surface of the support member and an upper side facing away from the upper surface of the support member, and each magnet is adjacent to a magnet having an upper surface of opposite polarity. The upper surfaces of the magnets of the support members can be joined to form a closure such that the magnets of one support members can be joined to the magnets of the other support member.

For purposes of summarizing the invention and the advantages achieved over the prior art, certain advantages of the invention have been described herein. Of course, it is to be understood that not necessarily all such advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other advantages as may be taught or suggested herein.

All of these embodiments are intended to be within the scope of the invention herein disclosed. These and other embodiments of the present invention will become readily apparent to those skilled in the art from the following detailed description of the preferred embodiments having reference to the attached figures, the invention not being limited to any particular preferred embodiment disclosed.

### BRIEF DESCRIPTION OF THE DRAWINGS

Embodiments of the present invention will now be described, by way of example only, with reference to the following drawings in which:

FIG. 1 is a simplified perspective view of a magnetic closure system in accordance with the invention, depicting a pair of panels each having a closure member of the closure system.

FIG. 2 is a cross sectional view of a mated pair of components of the magnetic closure system of FIG. 1, depicting a female component disposed above a male component.

FIG. 3 is a bottom perspective view of the female component of FIG. 2.

FIG. 4 is a top perspective view of the female component of FIG. 2.

FIG. 5 is a bottom perspective view of the male component of FIG. 2.

FIG. 6 is a top perspective view of the male component of FIG. 2.

FIG. 7 is an elevational view of the female component of FIG. 2.

FIG. 8 is a top view of the female component of FIG. 2

FIG. 9 is a cross sectional view of the female component, taken along ling A-A of FIG. 8.

FIG. 10 is an elevational view of the male component of FIG. 2.

FIG. 11 is a top view of the male component of FIG. 2

FIG. 12 is a cross sectional view of the male component, taken along ling A-A of FIG. 11

FIG. 13 is an exploded perspective view of another embodiment of a female component in accordance with the invention, comprising a ring portion disposed about a male component.

FIG. 14 is a perspective view of the female component of FIG. 13.

FIG. 15 is an elevational view of the male component of FIG. 13.

FIG. 16 is a bottom perspective view of the male component of FIG. 13.

FIG. 17 is a top view of the male component of FIG. 13.

FIG. 18 is a cross sectional view of the male component, taken along ling A-A of FIG. 17.

FIG. 19 is a top perspective view of the male component of FIG. 13.

FIG. 20 is a top view of the ring portion depicted in FIG. 13.

FIG. 21 is a cross sectional view of the ring portion, taken along ling A-A of FIG. 20.

FIG. 22 is a bottom perspective view of the ring portion of FIG. 20.

FIG. 23 is a top perspective view of the ring portion of FIG. 20.

FIG. 24 is a bottom perspective view of another embodiment of a male component in accordance with the invention, being inserted downward into another embodiment of a female component in accordance with the invention, having a periphery ridge.

FIG. 25 is a top perspective view of the male component of FIG. 24 being inserted downward into the female component of FIG. 24.

FIG. 26 is a bottom perspective view of another embodiment of a male component in accordance with the invention, having a square shape, being inserted downward into another embodiment of a female component in accordance with the invention, having a square shape and a periphery ridge.

FIG. 27 is a top perspective view of the male component of FIG. 26 being inserted downward into the female component of FIG. 26.

FIG. 27-A is a top perspective view of another embodiment of a female component in accordance with the invention, having a square shape, with partial peripheral ridges along three of its sides.

FIG. 28 is a top view of another embodiment of a male component in accordance with the invention, incorporating a screw into the design in order to fasten the component to the supporting member and/or panel.

FIG. 29 is a cross sectional view of the male component, taken along line A-A of FIG. 28.

FIG. 30 is a top perspective view of the male component of FIG. 28.

FIG. 31 is a bottom perspective view of the male component of FIG. 28.

FIG. 32 is a bottom view of another embodiment of a male component in accordance with the invention, incorporating a female fabric snap into the base in order to fasten the component to an existing male snap that is already affixed to a supporting member and/or panel.

FIG. 33 is a cross sectional view of the male component, taken along line A-A of FIG. 32.

FIG. 34 is a top perspective view of the male component of FIG. 32.

FIG. 35 is a bottom perspective view of the male component of FIG. 32.

FIG. 36 is a bottom view of another embodiment of a female component in accordance with the invention, incorporating a male fabric snap into the base in order to fasten the component to an existing female snap that is already affixed to a supporting member and/or panel.

FIG. 37 is a cross sectional view of the female component, taken along line A-A of FIG. 36.

FIG. 38 is a top perspective view of the female component of FIG. 36.

FIG. 39 is a bottom perspective view of the female component of FIG. 36.

FIG. 40 is a top perspective view of a unisex component in accordance with the invention.

FIG. 41 is a top view of the unisex component of FIG. 40.

FIG. 42 is a cross sectional view of the unisex component, taken along line A-A of FIG. 41.

FIG. 43 is a side view of the unisex component of FIG. 40, paired with a complementary unisex component.

### DETAILED DESCRIPTION OF THE PREFERRED EMBODIMENTS

This application references applicant's co-pending U.S. patent application Ser. No. 13/842,438, filed Mar. 15, 2013 (“the '438 application”), which is incorporated by reference for all purposes. At the time of invention, the inventions of the '438 application and the present application were and continue to be commonly owned.

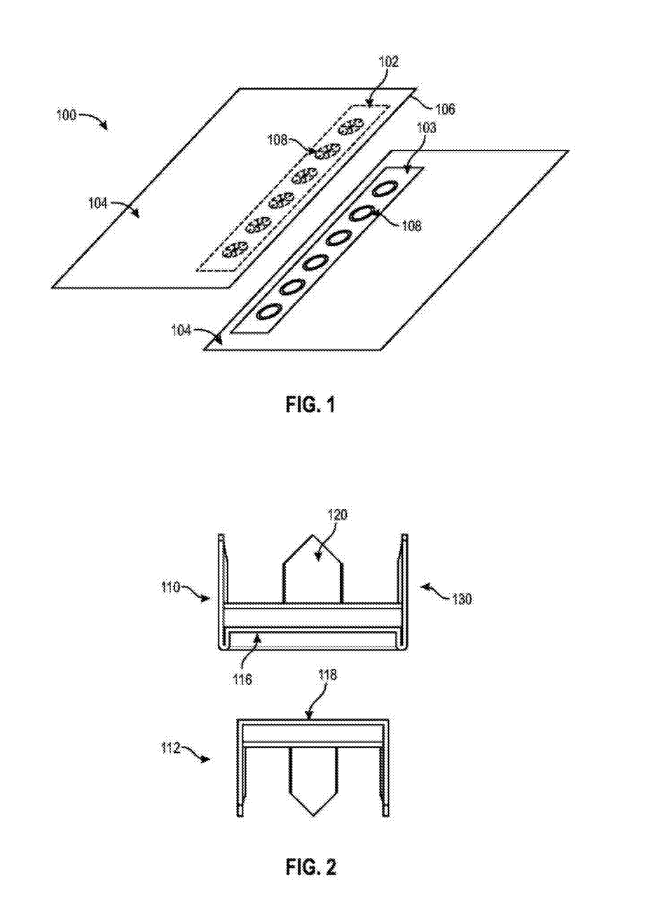

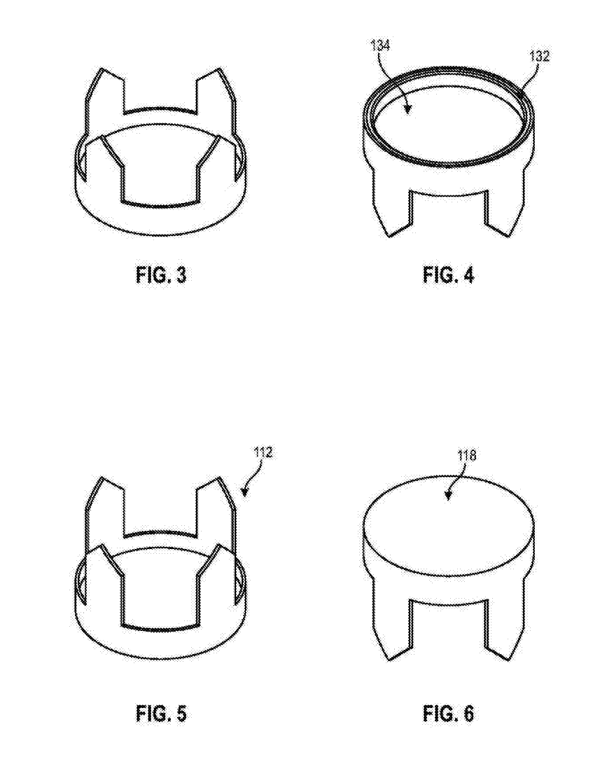

Referring now to the drawings, and particularly FIGS. 1 and 2, there is shown a closure system 100 that includes two closure members 102 that mate which each other to secure the panels 104 to each other along an elongated seam 106. The closure members comprise a plurality of magnetic pairs 108 spaced along the elongated seam. Each magnetic pair includes a female component 110 and a male component 112 (individually and collectively, also referred as, “magnetic components” 113). In order to fasten the two panels 104 together, the magnetic components are aligned with corresponding pairs 108, such that an upper contact surface 116 of a female component 110 is attracted to the upper contact surface 118 of the male component 112 via magnetic attraction, e.g., the male component and the female component configured with opposing polarity to provide magnetic attraction therebetween. The closure system 100 can be used in any variety of applications, e.g., clothing, sleeping bag, cushion cover, pillowcase, pillows, bedding, or a tent, among others.

In the exemplary embodiment, the first closure member 102 comprises all female components 110, while the second closure member 103 comprising all male components 112 aligned with the corresponding female components. In other embodiments, male and female components can be distributed between both closures members, so long as (magnetic) pairs 108 of components are aligned with each across the first closure member 102 and the second closure member 103. For example, male and female-components can be alternatively spaced on each closure member 102, 103, i.e., every other component alternating between male and female components, with a male component aligned across a female component along the first and the second closure members.

With continued reference to FIGS. 1 and 2, the male 112 and the female 110 components each include a plurality of elongated prongs 120 configured to pierce through the panel 104 and/or a supporting member 122. In the exemplary embodiment, the closure members 102, 103 include a supporting member 122 disposed between the magnetic components 113 and the panels 104.

The supporting member 122 can be a longitudinally extending band of flexible material, such as fabric, cloth or a flexible polymer material, among others. The magnetic components 113 are attached to the supporting members 122. The prongs 120 of the magnetic components pierce through the supporting member, however, additional attachment means can be used such as adhesive, to secure the magnetic components to the supporting member.

With the support member 122 and the magnetic components 113, closure members 102, 103 can be disposed in a continuous roll (not shown), in which case desired lengths of closure members 102, 103 can be provided by cutting portions of the roll in between the magnet components. Such a closure member 102, 103 can also be provided in discrete pieces of predetermined length. The closure members can be used to form a closure system 100 as described herein, by being attached to a desired location to connect panels 104.

In other embodiments, the magnetic components 113 can be attached in any of a variety of ways known to the art with or without a supporting member 122 disposed between the magnetic components and the panel 104. For example, magnetic components can be directly adhered via adhesive. Alternatively, the magnetic components can be secured in a casing 130, which can then be sewn or otherwise mechanically attached to a panel. In yet other embodiment, magnetic components can be attached directly to the panels with prescribed spacing, excluding a supporting member entirely.

With reference now to FIG. 2, the female component 110 comprises the magnet closed within a housing. The female component includes a peripheral ridge 132 that defines a cavity 134 for receiving an upper portion 118 of the male component 112. More particularly, the cavity has a diameter slightly larger than the diameter of the upper portion 118 of the male component, such that the male component is securely received within the cavity.

The magnets 108 of the closure system 100 can be disc magnets, and can be retained in a casing 130 having a pair of elongated prongs 120 extending away from the upper surface 116 118 for attaching the magnet casing 130 to a support member 122, with the prongs being positioned at the periphery of the casing. The magnets can be formed from neodymium, and preferably have a magnetic strength of between 36 MGOe and 52 MGOe, more preferably a magnetic strength of 42 MGOe. The magnets can be disposed at approximately equal distances from one another on the support member 122.

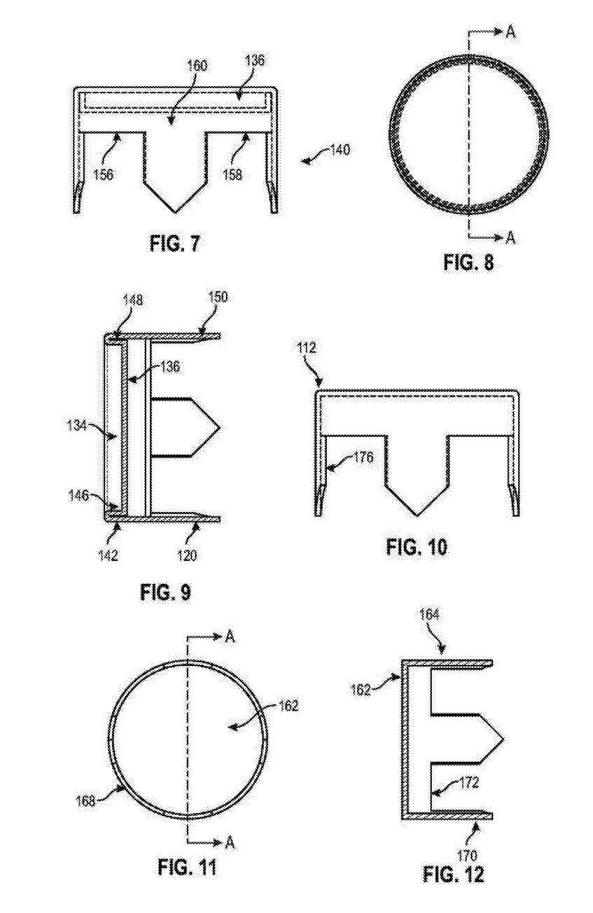

In the exemplary embodiment, the housing 140 includes an outer housing portion 142 that defines the ridge 146, outer sidewall 148, and outer portions 150 of the prongs 120 (see, e.g., FIGS. 7-9). The magnetic is disposed behind the planar wall 136 of the cavity 134. In the exemplary embodiment, the magnet has a diameter at least as wide as the diameter of the cavity. An interior housing portion 156 is disposed behind the magnet, forming a wall 158 of the magnet compartment 160. The interior housing portion can further include interior portions of the prongs 120, as shown in FIG. 2. The female component 110 can be formed of various materials that enable magnetic attraction. In the exemplary embodiment, the outer housing portion 142 is formed of stainless steel such as 316 stainless steel. The interior housing portion 156 is formed of stainless steel such as 440 stainless steel, which can be beneficial in various usages, e.g., apparel, auto, marine, furnishings, sporting goods, and footwear. In other embodiments, the housing can be formed of other material, e.g., such as polymeric material.

The male component 112 comprises a magnet disposed within a magnet compartment defined by the housing 164, that defines an outer surface 162 sized to be received within the cavity 134 of the female component 110. These magnetic components 113 are configured to be magnetically attracted to one another such that the male component is magnetically urged to be received within the cavity. In the exemplary embodiment, the housing 164 of the male component includes an outer housing portion 166 that defines the outer surface 162, outer sidewall 168, and outer portions of the prongs 170 (see, e.g., FIGS. 10-12). The magnet is disposed behind the planar wall of the cavity. An interior housing portion 172 is disposed behind the magnet, forming a wall of the magnet compartment 174. The interior housing portion can further include interior portions 176 of the prongs, as shown in FIG. 2. In the exemplary embodiment, the outer housing portion 166 of the male component is formed of stainless steel such as 316 stainless steel. The inner housing portion 172 of the male component is formed of stainless steel such as 440 stainless steel.

In other embodiments, the housings of the male and the female components can be formed of polymeric material(s). In assembly, the prongs puncture the supporting member and/or panel. The prongs and/or other portions of the housing are then melted to fuse with the supporting member and/or panel. For example, a thermoplastic polyurethane is coated over the magnet.

Alternatively, a support member or panel can be punctured by separate structure, thereafter, a melted polymer is dispensed onto the structure into which a magnet is positioned. As a result, the housing for the magnet can be formed by hardening of the polymer. The resulting housings can be structured as discussed herein.

It is further noted that hot melts adhesive can be provided to aid in securing the components together (e.g., magnet, housing, supporting member, panel or others). For example, hot melts adhesive can be disposed between the male component (or female component) and the supporting structure or panel, thereby forming a mechanical interlock between the fabrics and magnetic parts.

In another embodiment, best seen in FIGS. 28-31, a male component 230 of a magnetic closure system in accordance with the present invention is designed to incorporate a screw 232 into its base, in order to affix the component 230 to a support member or panel. This male component 230 includes a slot 231 to drive the screw 232 into the support member or panel, as well as a ring magnet 233 by which the component may magnetically couple to a complementary component.

With reference now to FIGS. 7-9, the outer portion of the housing 142 of the female component 110 is shown, to include particular measurements of an exemplary embodiment to conform with a corresponding male component 112 depicted in FIGS. 10-12. These measurements are provided as illustrative and not intended to be limiting. In the exemplary embodiment, the periphery ridge 132 of the female component 112 completely circumscribes the cavity 134. In other embodiments, the ridge 132 can have spaced apart portions. It need not extend about the cavity in an uninterrupted manner. Portions can be spaced about the cavity, while still contributing to securing the male component within the cavity.

In the exemplary method of manufacture, the outer portion of the housing 142 is made of a unitary blank of material formed into shape. The disc-shaped magnet is disposed behind the wall of the cavity 134. Thereafter, the interior housing portion 156 is disposed behind the opposing side of the magnet. The interior portion of the housing is made of a unitary blank of material formed into shape.

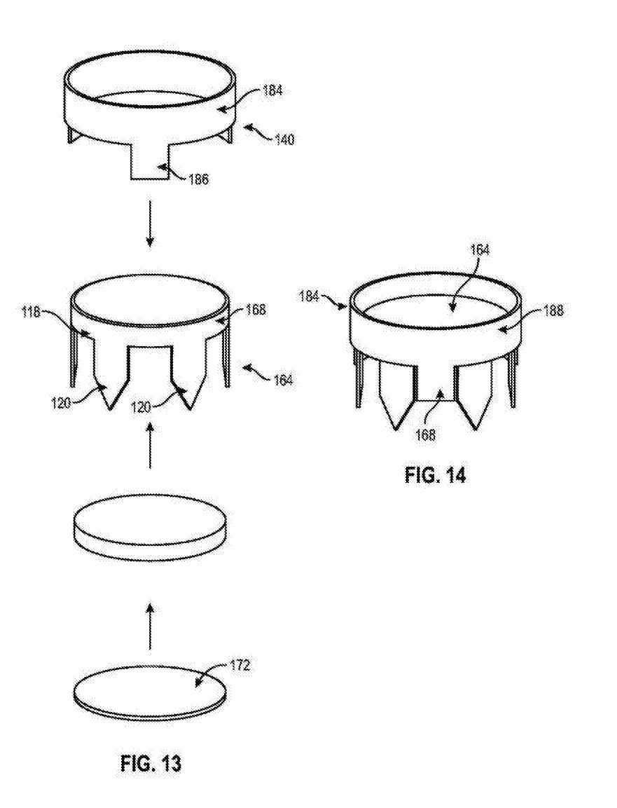

With reference now to FIGS. 13 and 14, a female component 110 and a male component 112 of another embodiment of magnetic components are shown, in accordance with the invention. The male component comprises an outer housing portion 166, a disc-shaped magnet 180 received behind an outer wall 168 of the outer housing portion, and an interior housing portion 172 disposed behind the magnet. The male component includes plurality of prongs 120 that extend from the outer wall 168. The female component 110 is formed by providing a ring portion 184 about a male component 112. It is noted the magnets used in the resulting female component have an opposing polarity than those under in the resulting male component to provide magnetic attraction therebetween. The ring portion includes flaps 186 extending from a cylindrical sidewall 188. The flaps are sized to extend beyond the upper portion 118 of the male component so that they can be folded behind the interior housing portion 172, securing the ring portion in place.

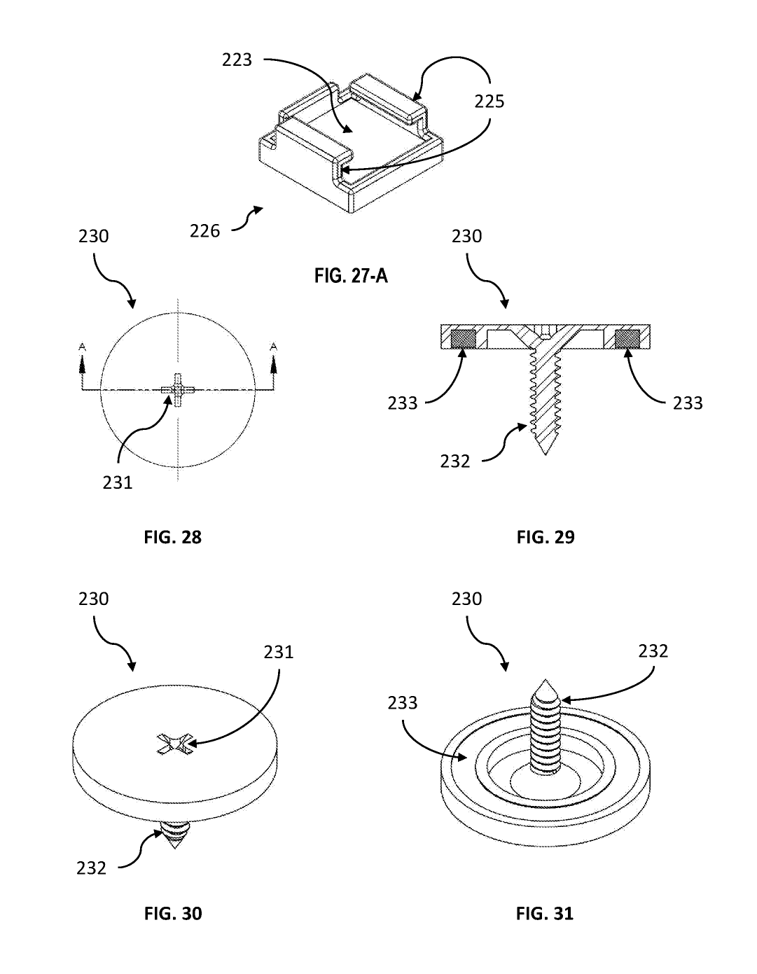

The ring portion 184 can be similarly disposed about any compatible male component in order to make a corresponding female component. For example, the ring portion 184 can be disposed about the male component 230 depicted in FIGS. 28-31 in order to make a corresponding female component. Similarly, a squared ring portion could be disposed about a square-shaped male component, similar to the male component 220 depicted in FIGS. 26-27 to make a corresponding female component. Furthermore, the ring portion can incorporate additional elements depending on the intended application of a particular closure member. For example, the ring portion can incorporate tabs, notches, or, as will be discussed below, rimmed containment walls.

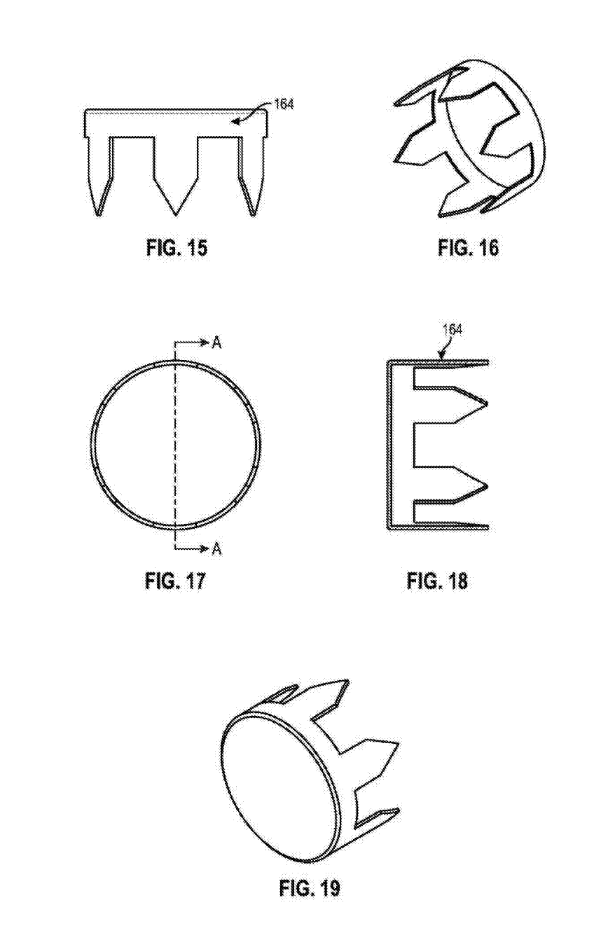

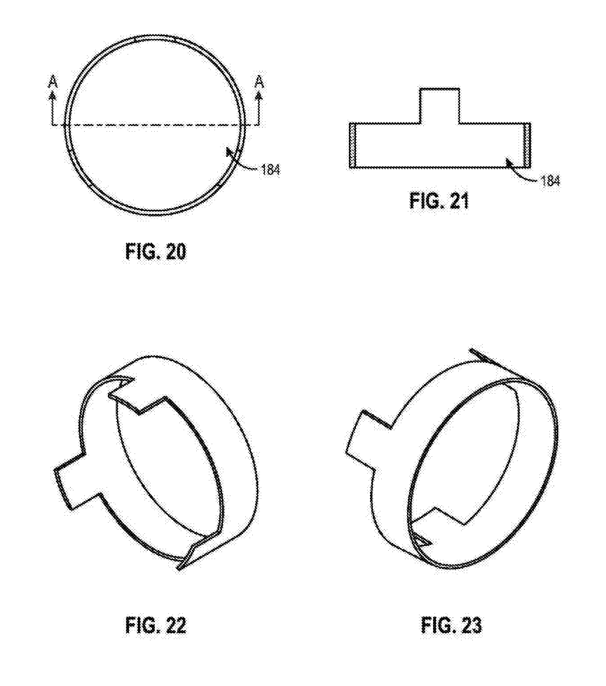

With reference now to FIGS. 15-19, the outer portion of the male housing 164 is shown, to include particular measurements of the embodiment of FIG. 13. These measurements are provided as illustrative and not intended to be limiting. The ring portion 184 has a diameter that closely conforms to the upper end of the male housing 164.

Magnets chosen for use in the closure system 100 (FIG. 1) have sufficient magnetic strength to securely close an opening for the selected item. For example, when the item is a garment, the magnets should maintain closure despite pressure placed on the garment, the seam, and the closure system 100 via movement by the wearer of the garment. The magnets preferably should stay joined through a full range of movement and withstand the force applied on the garment by that movement, to ensure that the seam does not come unexpectedly apart. Conversely, the magnets should not be so strong as to make the opening of the closure, such as the separation of the panels, overly difficult or cumbersome.

In selected embodiments, examples of usable magnets for the closure system can include magnets and programmed magnets sold under the brand names MaxField® and Polymagnet®, available from Correlated Magnetic Research LLC. Such magnets can provide a concentrated magnetic flux proximate to the surface of the magnet. In many usages, magnets having a thickness ¾ × 1/32 or ¾ × 1/16 will often be used; however, the thickness of the magnet and the diameter of the magnet may vary according to its application. For example, magnets, e.g., neodymium, are often in the shape of a disc but may be a square or rectangle or uniquely designed shape for esthetics and fashion. Often, the magnets are axially magnetized in a grade N40 but may go up or down in its strength of the neodymium used depending on the intended application for its use.

Because strong, coupled magnets are difficult to separate by a straight pull-apart force, but separation of magnets by a sideways sliding action requires significantly less force, other embodiments are envisioned in accordance with the present invention, which allow for sliding action but not pulling action. One such embodiment involves a round male component 200 which includes a tab-like protrusion 204 around its magnet 201. This protrusion 204 slides into a rimmed containment wall 205 on a matching female component 202. Similarly, a square version of this embodiment would comprise a square male component 220 with tabs 224 alongside its magnet 221. These tabs 224 would slide into rimmed containment walls 225 around and above the magnet 223 on a corresponding female component 222. These embodiments are designed to prevent a male component from moving orthogonally away from the base of its mated female component, as is allowed by the periphery ridge 132 of the female components described in the embodiments above, while requiring less force of separation by allowing the male components to move slidingly away from the female components.

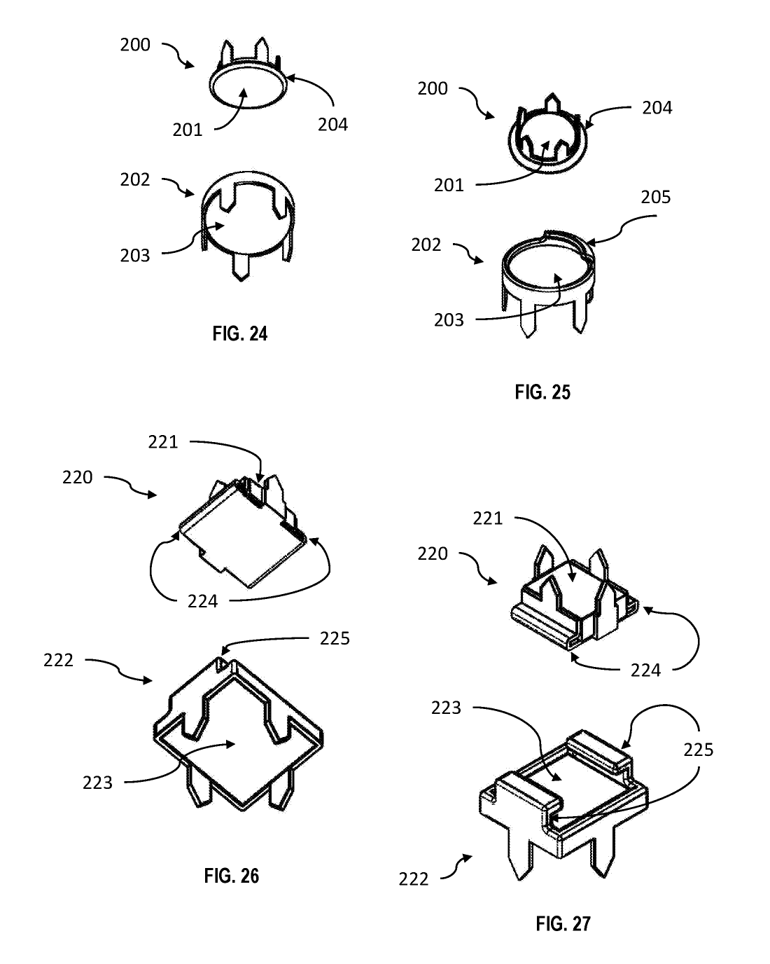

The tab-like protrusions 204, 224 as depicted in FIGS. 24-25 have a semicircular cross-section, but can be comprised of straight surfaces. Similarly, the rimmed containment walls can be comprised of semicircular surfaces 205 or straight surfaces 225, so long as the walls can receive the tab-like protrusions of the corresponding male component. Furthermore, the sliding action of the male component can be restricted as desired by including more or less rimmed containment walls on the corresponding female component.

For example, a designer may desire a magnetic closure system on a coat which only allows for separation when the front flaps of the coat are pulled closer together (i.e., making the jacket tighter) in order to prevent accidental separation. In this example, a square, tabbed male component 220 could be incorporated on the left front flap of a coat, overlapping a square female component 222 on the right front flap, with the female component 222 having horizontal rimmed containment walls 225 on the top and bottom edges of the magnet 223 and an additional rimmed containment wall located vertically on the left side of the magnet 223. The three rimmed containment walls on the female component 222 would thus form a bracket-shaped or three-sided square closure, allowing the tabbed male component 220 to slide in or out only through the right side of the female component 222. In this fashion, the male component 220 could be separated only by pulling the left front flap of the jacket to the right, tighter across the wearer's body, and sliding the male component 220 out of the rimmed containment walls 225 of the female component 222 to the right. Such an embodiment would prevent the coat from accidentally coming undone by either pulling the magnetic closure system apart or by sliding the corresponding magnets in any other direction except for to the right.

As another example, a canvas cover for a boat could be made to include circular tabbed male components 200 along the outer seam. Circular female components 202 could be attached to the hull of the boat, such that the C-shaped rimmed containment wall 205 extends across the top or innermost half of its magnet 203 with the opening of the C-shape along the edge of the magnet 203 closest to the ocean. In this embodiment, each male component 200 of the boat cover would be slid into the C-shaped rimmed containment wall 205 of each corresponding female component 222 of the boat's hull, with enough slack in the boat cover to allow the male component 220 to slide in and out of the female component 222, but with enough tension in the boat cover to pull the male components 220 against the rimmed wall brackets 225 of the female components 222 to prevent accidental separation.

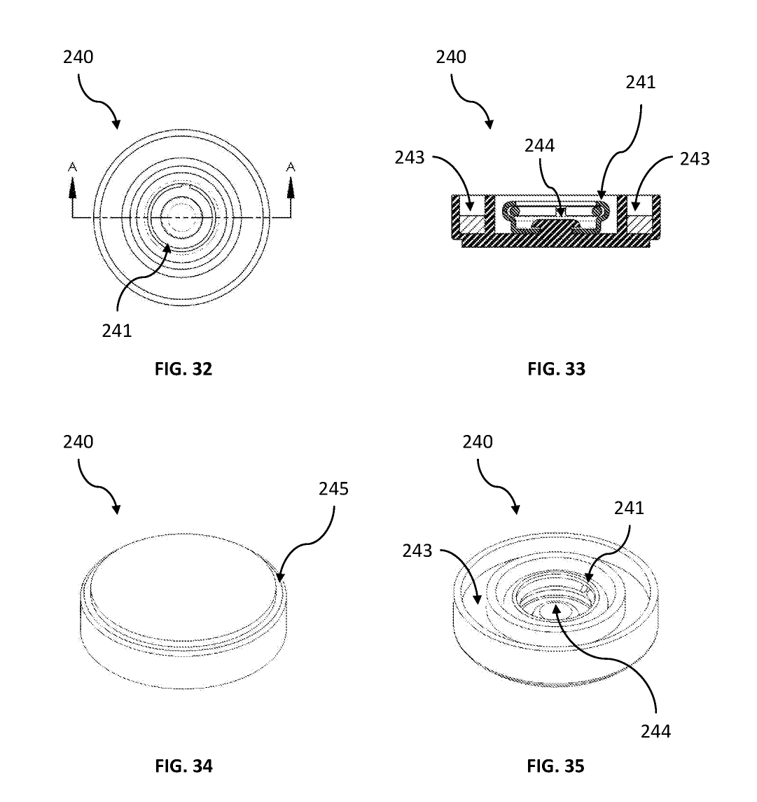

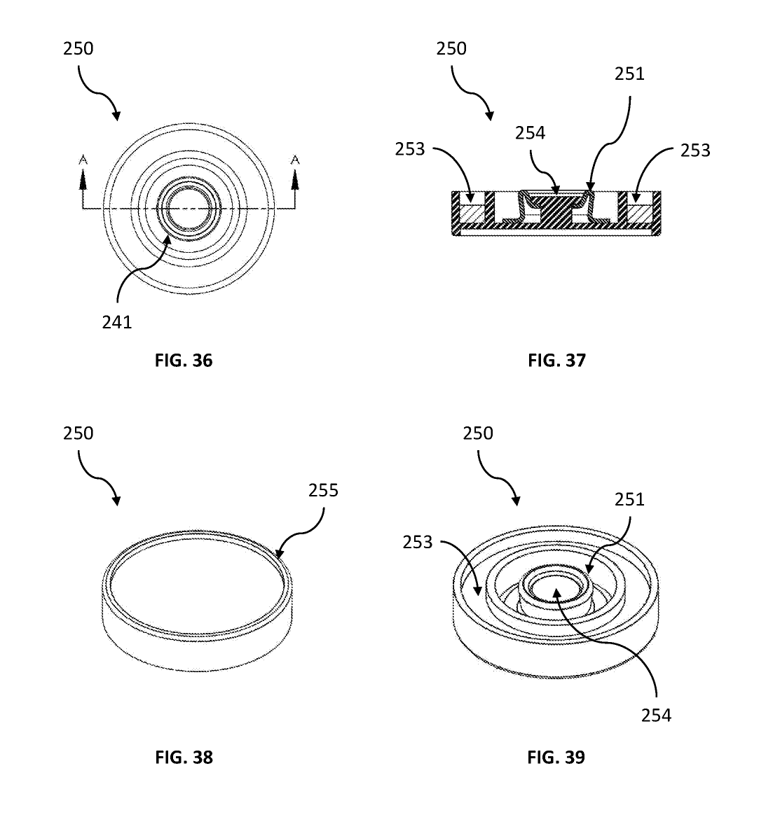

With reference now to FIGS. 32-35, a male component 240 is depicted in accordance with the present invention. This embodiment includes a female snap receptacle 241 by which the component 240 can be affixed to a male snap component that is fastened to a support member or panel. This embodiment allows users to retrofit in situ snap closure members, without having to remove the installed snaps and then install the new magnetic closure members. The male component 240 includes a rivet 244 to retain the female snap 241, as well as a ring magnet 243 which allows for mating with a corresponding female component 250.

The corresponding female component 250 of this embodiment includes a ring magnet 253 of opposing polarity to the ring magnet 243 of the male component 240, by which the male component 240 is magnetically attracted and held in place. Furthermore, the female component 250 has a peripheral ridge 255, into which the peripheral lip 245 of the male component 240 is inserted, to keep the male component 240 from slidingly detaching. This peripheral ridge 255 can also take the form of a rimmed containment wall as disclosed above, to prevent the male component from moving orthogonally away from the surface of the female component yet allow the male component to move slidingly away from the female component in a direction not blocked by the partial peripheral ridge. The female component 250 includes a male snap fastener 251, retained to the female component 250 by a rivet 254. This male snap fastener 251 allows the female component 250 to be affixed to a female snap component that is fastened to a support member or panel.

This “retrofit” embodiment allows the present invention to be quickly and easily installed over existing snap closures, wherever those traditional snap closures are located, whenever the magnetic closure system described herein is preferred.

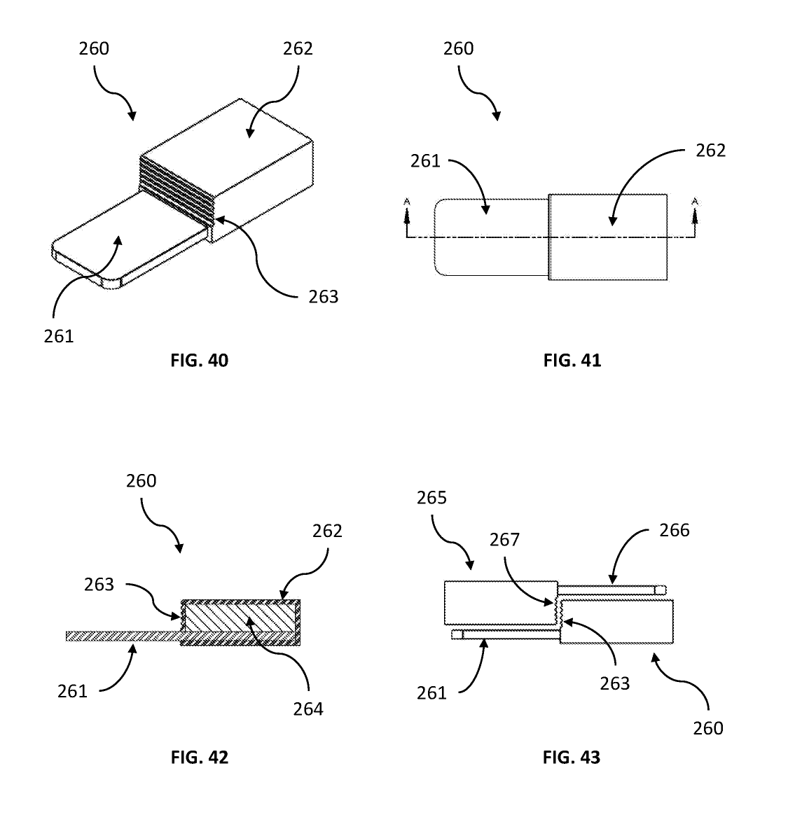

With reference now to FIGS. 40-43, a unisex component 260 is depicted in accordance with the present invention. This embodiment includes a magnet 264 contained in a housing 262, with a base plate 261 extending along the bottom of the housing 262 and out to one side of the housing 262. The unisex component 260 is mated with a complementary unisex component 265, having a magnet of opposing polarity to the one in the first unisex component 260, in order to form a complete magnetic closure pair as depicted in FIG. 43.

In one version of this embodiment, a ferromagnetic material such as steel is used for the base 261. The permanent magnet 264 contained in the housing 262 induces a magnetic field in the ferromagnetic base 261, such that a complementary unisex component 265 is thereby attracted to the base 261. Similarly, in this version of the embodiment, the base 266 of the complementary unisex component 265 would be magnetically attracted to the permanent magnet 264 of the first unisex component 260.

The housing 262 of this unisex component 260 has peripheral ridges 263 along the side of the housing 262 which interfaces with the peripheral ridges 267 of a complementary unisex component 265. The peripheral ridges 263, 267 serve a purpose similar to that of the peripheral ridge with a rimmed containment wall 205 described in the embodiment of the female component 202 depicted in FIG. 25. Specifically, the peripheral ridges 263, 267 inhibit the complementary unisex component 265 from moving orthogonally away from the base 261 of the first unisex component 260, while still allowing the complementary unisex component 265 to move slidingly away from the first unisex component 260. The peripheral ridges 263, 267 can be reoriented to best prevent separation between the unisex components, depending on the intended application for the closure system. Although the present invention has been described in considerable detail with reference to certain preferred embodiments, other embodiments are possible. The steps disclosed for the present methods, for example, are not intended to be limiting nor are they intended to indicate that each step is necessarily essential to the method, but instead are exemplary steps only. Therefore, the scope of the appended claims should not be limited to the description of preferred embodiments contained in this disclosure.

Recitation of value ranges herein is merely intended to serve as a shorthand method for referring individually to each separate value falling within the range. Unless otherwise indicated herein, each individual value is incorporated into the specification as if it were individually recited herein. All references cited herein are incorporated by reference in their entirety.

Although the invention has been disclosed in detail with reference only to the exemplary embodiments, those skilled in the art will appreciate that various other embodiments can be provided without departing from the scope of the invention. Accordingly, the invention is defined only by the claims set forth below.

What is claimed is:

1. A magnetic closure system, comprising:
a first component having an outer housing portion, a magnet received behind an outer wall of the outer housing portion, and an interior housing portion disposed behind the magnet to trap the magnet between the outer housing portion and the interior magnet portion; and
a second component having a magnet closed within a housing and a peripheral ridge around at least part of the housing to receive the outer housing portion of the first component and prevent the first component from moving orthogonally away from the surface of the second component yet allow the first component to move slidingly away from the second component in a direction not blocked by the partial peripheral ridge.

2. The magnetic closure system of claim 1, wherein both the first component and second component have partial peripheral ridges to prevent the components from moving orthogonally away from the surface of a complementary component yet allow the components to move slidingly away from another component in a direction not blocked by the peripheral ridges.

3. The magnetic closure system of claim 1, wherein the first component, the second component, or both components include at least one fastener to affix the component to a support member or panel or other fastener already so affixed.

4. The magnetic closure system of claim 1, wherein the second component includes an outer housing portion, the magnet received behind an outer wall of the outer housing portion, and an interior housing portion disposed behind the magnet to trap the magnet between the outer housing portion and the interior magnet portion, the outer housing portion including at least one fastener to affix the component to a support member or panel or other fastener already so affixed.

5. The magnetic closure system of claim 1, wherein the partial peripheral ridge of the second component is defined by a ring attached via flaps folded over the housing of the second component.

6. The magnetic closure system of claim 2, wherein the partial peripheral ridge of the second component is defined by a ring attached via flaps folded over the housing of the second component.

7. The magnetic closure system of claim 1, comprising:
a plurality of magnetic pairs, each pair consisting of the first component and the second component;
a first closure member disposed along a first side of an elongated seam, having components of the magnetic pairs spaced along the first side of the elongated seam; and
a second closure member disposed along a second side of an elongated seam, having corresponding components of the magnetic pairs spaced along the second side of the elongated seam, such that the magnetic components are aligned with corresponding pairs, such that an upper contact surface of a second component is attracted to the upper contact surface of a first component via magnetic attraction, and such that the partial peripheral ridge on the second component prohibits movement of the first component in the direction orthogonally away from the surface of the second component and in the direction away from the seam.

8. The magnetic closure system of claim 7, wherein the first components, the second components, or both sets of components include at least one fastener to affix the component to one of the closure members or another fastener so affixed.

9. The magnetic closure system of claim 8, wherein at least one fastener is formed of polymeric material, in which the fastener punctures a supporting member and is melted to fuse with the supporting member.

10. The magnetic closure system of claim 7, wherein both the first component and second component have partial peripheral ridges to prevent the components from moving orthogonally away from the surface of a complementary component yet allow the components to move slidingly away from another component in a direction not blocked by the partial peripheral ridge.

11. The magnetic closure system of claim 7, wherein the partial peripheral ridge of each of the second components of the plurality of magnetic pairs, is defined by a ring attached via flaps folded over the housing.

12. The magnetic closure system of claim 3, wherein the partial peripheral ridge of the second component is defined by a ring attached via flaps folded over the housing of the second component.

13. The magnetic closure system of claim 3, wherein at least one fastener is formed of polymeric material, in which the fastener punctures a supporting member and is melted to fuse with the supporting member.

14. The magnetic closure system of claim 3, comprising:
a plurality of magnetic pairs, each pair consisting of the first component and the second component;
a first closure member disposed along a first side of an elongated seam, having components of the magnetic pairs spaced along the first side of the elongated seam; and
a second closure member disposed along a second side of an elongated seam, having corresponding components of the magnetic pairs space along the second side of the elongated seam, such that the magnetic components are aligned with corresponding pairs, such that an upper contact surface of a second component is attracted to the upper contact surface of the first component via magnetic attraction, and such that the partial peripheral ridge on the second component prohibits movement of the first component in the direction orthogonally away from the surface of the second component and in the direction away from the seam.

15. The magnetic closure system of claim 14, wherein the peripheral ridge of each of the second components of the plurality of magnetic pairs, is defined by a ring attached via flaps folded over the housing.

16. The magnetic closure system of claim 14, wherein at least one fastener is formed of polymeric material, in which the fastener punctures a supporting member and is melted to fuse with the supporting member.

17. A magnetic closure system, comprising:
a first component having an outer housing portion, a magnet compartment defined behind an outer wall of the outer housing portion, and an interior housing portion disposed behind the magnet compartment to trap a magnet between the outer housing portion and the interior housing portion, and at least one fastener to affix the component to a support member or panel or other fastener already so affixed; and
a second component defining a magnet compartment for receiving a magnet within a housing and a peripheral ridge around at least part of the housing to receive the outer housing portion of the first component and prevent the first component from moving orthogonally away from the surface of the second component yet allow the first component to move slidingly away from the second component in a direction not blocked by the partial peripheral ridge, and at least one fastener to affix the component to a support member or panel or other fastener already so affixed.

18. The magnetic closure system of claim 17, wherein the peripheral ridge of the second component is defined by a ring attached via flaps folded over the housing of the second component.

19. The magnetic closure system of claim 17, wherein the fasteners of the first component and the second component are formed of polymeric material, in which the fasteners puncture a supporting member and are melted to fuse with the supporting member.

20. A magnetic closure system comprising:
a first component having an outer housing portion, a magnet received behind an outer wall of the outer housing portion, and an interior housing portion disposed behind the magnet to trap the magnet between the outer housing portion and the interior magnet portion; and
a second component having a magnet closed within a housing and a peripheral ridge that defines a cavity for receiving an upper portion of the male component;
wherein the first component, the second component, or both components include at least one fastener to affix the component to a support member or panel or other fastener already so affixed.
